(19) United States
(12) Patent Application Publication
(10) Pub. No.: US 2024/0086253 A1
(43) Pub. Date: Mar. 14, 2024

(54) SYSTEMS AND METHODS FOR INTENT-BASED ORCHESTRATION OF A VIRTUALIZED ENVIRONMENT

(71) Applicant: Verizon Patent and Licensing Inc., Basking Ridge, NJ (US)

(72) Inventors: Sivanaga Ravi Kumar Chunduru Venkata, Irving, TX (US); Vinod Ramalingam, Irving, TX (US); Anil Kumar Pabbisetty, Irving, TX (US)

(73) Assignee: Verizon Patent and Licensing Inc., Basking Ridge, NJ (US)

(21) Appl. No.: 17/930,452

(22) Filed: Sep. 8, 2022

(51) Int. Cl. G06F 9/50; G06F 9/455; G06F 40/30

(52) U.S. Cl. CPC G06F 9/5077; G06F 9/45558; G06F 40/30; G06F 2009/4557; G06F 2009/45595

(57) ABSTRACT

A system may select a set of containers to implement a requested service; identify parameters of the set of containers, and maintain information including parameters associated with a plurality of nodes of the virtualized environment. The parameters for one or more of the plurality of nodes may include information associating the one or more nodes with respective elements of the network. The system may compare the parameters of the one or more containers to the parameters of the one or more nodes, and select a set of nodes of the plurality of nodes on which to deploy the selected set of containers. The selecting may include selecting, for each container of the set of containers, a respective node of the set of nodes on which to deploy the each container. The system may deploy the selected set of containers to the set of nodes to implement the requested service.

### BACKGROUND

Wireless networks or other systems may make use of virtualized environments, which may include nodes that are implemented by virtual machines, cloud systems, bare metal devices, etc. Containerized processes, or containers, may be instantiated on the nodes. In the context of a software-defined network (“SDN”), the containers may implement one or more network functions of the SDN. Some services, application suites, etc. may be implemented by multiple containers that may be installed, instantiated, etc. at different nodes within a virtualized environment.

### BRIEF DESCRIPTION OF THE DRAWINGS

FIG. 1 illustrates an example overview of one or more embodiments described herein;

FIG. 2 illustrates an example data structure that includes container attributes, in accordance with some embodiments;

FIGS. 3 and 4 illustrate examples of a selection of a set of containers to implement a particular service, in accordance with some embodiments;

FIG. 5 illustrates an example deployment of a service to nodes of one or more networks, in accordance with some embodiments;

FIG. 6 illustrates an example architecture of a virtualized environment, in accordance with some embodiments;

FIG. 7 illustrates an example process for deploying a set of containers to a set of nodes in order to automatically implement a requested service, in accordance with some embodiments;

FIG. 8 illustrates an example environment in which one or more embodiments, described herein, may be implemented;

FIG. 9 illustrates an example arrangement of a radio access network (“RAN”), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for the automated deployment of sets of containers at various nodes that are deployed throughout a network. As discussed herein, a set of containers may cooperatively provide a particular service or set of services, a solution, an application, an application suite, etc., such as an augmented reality (“AR”) service, an autonomous vehicle control service, a gaming service, a videoconferencing service, and/or some other type of service via the network. Some containers may perform particular computations, calculations, processing, or the like, as part of implementing their respective functionality with respect to the provided service. For example, an autonomous vehicle control service may be associated with real time or near-real time aspects (e.g., performing computer vision processing on images or video captured in real-time, providing throttle or brake controls, etc.) and may also be associated with non-real time aspects, such as artificial intelligence/machine learning (“AUML”) model generation and refinement. The real time or near-real time aspects may be considered as “latency-sensitive” aspects of the autonomous driving service, because performing such aspects as quickly as possible (including fast processing by one or more processors and fast communication of processed traffic via a network) may provide an increased measure of performance, user experience, or other suitable metrics. On the other hand, the non-real time aspects may be considered as “latency-insensitive” or “non-latency-sensitive” services, because performing these aspects relatively quickly may have relatively low or no effect on performance, user experience, etc. as compared to performing such aspects in a less expedient manner.

As such, containers that perform operations related to latency-sensitive services, aspects or portions of services, etc., may be deployed physically closer to devices that receive such services (e.g., User Equipment (“UEs”) such as mobile telephones, Internet of Things (“IoT”) devices, autonomous vehicles, automated factory robots, etc.), sometimes referred to as being deployed at the “edge” or “edges” of a network. For example, some such containers may be implemented by a Multi-Access/Mobile Edge Computing (“MEC”) device, referred to sometimes herein simply as a “MEC,” that is communicatively coupled to a base station of a RAN. That is, a node on which such a container is installed may be, may include, may be implemented by, etc. a MEC. As another example, such containers may be implemented by another type of node, such as an on-site datacenter or other facility that is co-located with, or is located within a threshold proximity of, wireless network infrastructure equipment such as radios, antennas, base stations, etc.

On the other hand, containers that perform operations related to latency-insensitive services may be deployed physically farther away from devices that receive such services, such as via a cloud system, a system that is accessible via the Internet and/or one or more other networks, etc. That is, a node on which such a container is installed may be, may include, may be implemented by, etc. a cloud system, an Internet-accessible device or system, etc.

Implementing containers farther from devices that receive such services may be more cost-effective and may allow for more flexibility than implementing containers at the edges of networks. Implementing containers at the edges of networks may provide reduced latency and/or other increased performance metrics. Embodiments described herein provide for the identification and deployment of containers, that are associated with a requested service, at appropriate nodes based on attributes of the service and/or of the containers. For example, embodiments described herein allow for a particular service and/or attributes of a service to be requested, the automatic identification of a set of containers that satisfy the requested service, the automatic identification of a particular set of nodes to implement the identified containers (e.g., where the nodes are identified such that performance requirements or other attributes of the service are maintained, and/or are identified based on load balancing or network conditions), and the deployment of the containers to the respectively identified nodes. The automated deployment of multiple containers, at the granularity of selecting a particular node for each container associated with a requested service, may serve to optimize service performance and network efficiency, without requiring manual evaluation and selection by a network operator, administrator, etc. Further, such deployment may be carried out such that performance thresholds or other constraints or requirements of a set of services may be maintained, thus delivering the level of performance and/or user experience that is commensurate with the provided service.

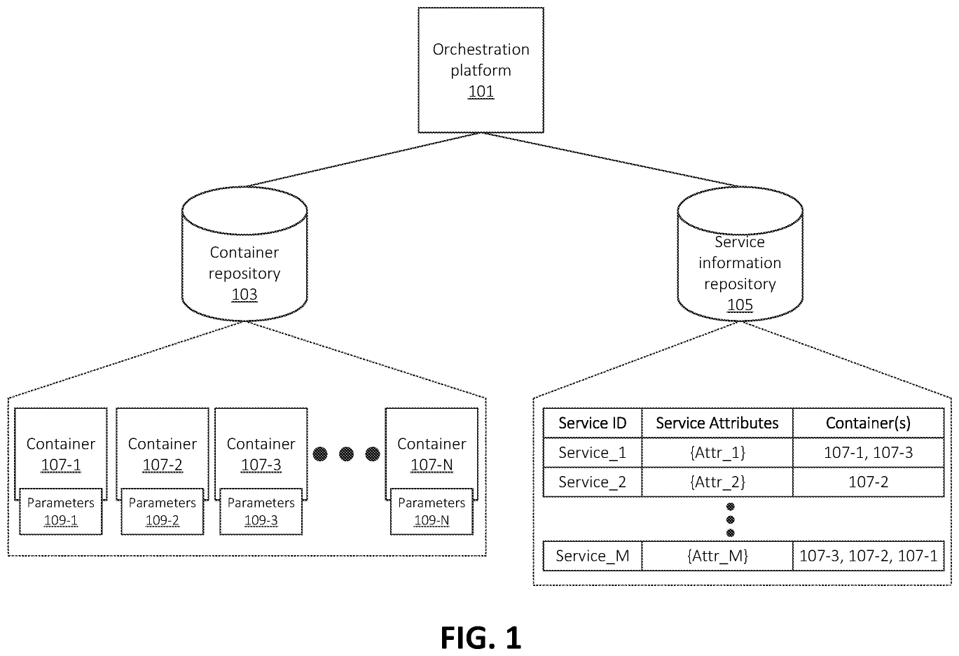

As shown in FIG. 1, orchestration platform 101 of some embodiments may include and/or may otherwise have access to container repository 103 and service information repository 105, in accordance with some embodiments. For example, container repository 103 and/or service information repository 105 may be maintained via one or more storage devices that are included in and/or are communicatively coupled to a device or system (e.g., a datacenter, a web server, a cloud system, etc.) that implements orchestration platform 101. As discussed below, orchestration platform 101 may be communicatively coupled to one or more nodes of a virtualized environment, and may configure aspects of the virtualized environment. For example, orchestration platform 101 may instantiate, install, etc. nodes on virtual machines, bare metal hardware resources, etc., and/or may instantiate, install, etc. containers onto particular nodes. Orchestration platform 101 may perform one or more other operations with respect to containers, nodes, etc. of a virtualized environment, as discussed below.

In some embodiments, container repository 103 may include and/or may include information associated with one or more containers 107 (e.g., containers 107-1 through 107-N, in this example). For example, container repository 103 may include installation packages, images, processor-executable code, etc., associated with one or more images 107. Additionally, or alternatively, container repository 103 may include references to such containers 107, such as container names, container identifiers, hyperlinks, Uniform Resource Locators (“URLs”), etc. that uniquely identify containers 107 and/or that link to installation packages or other resources associated with respective containers 107.

As noted above, each container 107 may include a set of functions, computations, etc. When installed, instantiated, executed, etc. at a given node, the node may perform some or all of the functions, computations, etc. specified by container 107. Container repository 103 may also store information indicating a particular set of parameters 109 associated with each container 107. For example, container 107-1 may be associated with parameters 109-1, container 107-2 may be associated with parameters 109-2, and so on. Parameters 109 may include tags, labels, identifiers, thresholds, and/or other information associated with respective containers 107.

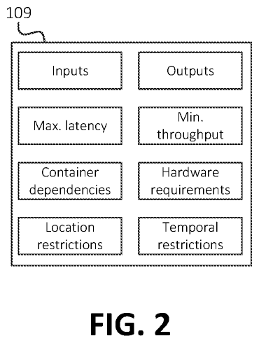

For example, as shown in FIG. 2, an example set of parameters 109 may include information such as “inputs,” “outputs,” “maximum latency,” “minimum throughput,” “container dependencies,” “location restrictions,” “hardware requirements,” and “temporal restrictions.” In practice, parameters 109 associated with a given container 107 may include additional, fewer, and/or different attributes than those shown in the figure. In some embodiments, some or all parameters 109 associated with a particular container 107 may be provided by an operator, developer, application provider, etc. Additionally, or alternatively, one or more attributes of 109 may be automatically generated or refined via AI/ML techniques or other suitable modeling techniques.

Parameters 109 specifying inputs may specify, for example, a set of input values, variables, format, etc. to be provided to a given container 107 in order for container 107 to perform one or more specified functions. For example, a given container 107 associated with an AR service may specify that input data should include video data of a given framerate, resolution, etc. Another container 107 associated with a gaming service may specify one or more game-related variables, a user account identifier, etc. as input data. Similarly, outputs may specify variables, values, an output format, etc. of information that is generated via operation of a given container 107, which may result from one or more computations, calculations, etc. performed based on a set of input values or other based on other factors.

Parameters 109 may also include QoS information, Service Level Agreements (“SLAs”), performance thresholds, or the like. For example, parameters 109 may specify a maximum amount of latency associated with a given container 107, which may be used to indicate a maximum processing time for processing or other operations associated with container 107, a maximum round-trip time for operations associated with container 107 (e.g., which may include network latency associated with input data provided to container 107 as well as network latency associated with a response provided by container 107), a one-way delay time (e.g., which may include network latency associated with providing traffic from container 107 to a given UE or other device), etc. For example, a gaming service may be associated with a relatively low maximum latency, while a file transfer service may be associated with a relatively high maximum latency or no specified maximum latency. As another example, the QoS information, SLAs, etc. may include a minimum throughput, which may indicate a minimum amount of network throughput or bandwidth required for traffic to or from container 107. For example, an AR service may be associated with a relatively high minimum throughput, while a messaging service may be associated with a relatively low minimum throughput.

Parameters 109 may also specify container dependencies, which may indicate other associated or related containers 107. For example, parameters 109-1 associated with container 107-1 may specify that the output of another container (e.g., container 107-2) is required as input of container 107-1. As another example, parameters 109-1 associated with container 107-1 may specify that if parameters 109-1 is installed at a particular node, then parameters 109-2 is required to also be installed at the same particular node. As yet another example, parameters 109-1 associated with a given container 107 may specify that another container 107 is not permitted to be installed at the same node. In some embodiments, other examples of container dependencies, constraints, restrictions, etc. may be included in parameters 109. In some embodiments, the container dependencies, restrictions, etc. may specify containers 107 by name or identifier, by type, by category, by tags, by one or more conditions or criteria, and/or may otherwise suitably specify one or more containers 107.

Parameters 109 may also include hardware requirements, such as a type of a particular device or system that implements a node on which container 107 is installed (e.g., a MEC, a datacenter, a cloud-based system, etc.). As another example, the hardware requirements may specify types of devices, peripherals, etc. required by a given container 107 (e.g., a camera, a sensor, etc.). As yet another example, the hardware requirements may specify a type or amount of hardware resources, such as processing resources, a particular type or quantity of processors, a minimum processor speed, a minimum amount of random access memory (“RAM”), a minimum amount of storage space, a type of storage device (e.g., solid state disk (“SSD”), flash memory, etc.), and/or other hardware resource parameters.

Parameters 109 may also specify location-based and/or temporal restrictions, requirements, etc. For example, parameters 109 for a given container 107 may specify that container 107 is required to be installed within a given geographical region, at a particular node, within a particular building, etc. Additionally, or alternatively, location-based restrictions may specify one or more regions, buildings, etc. in which a given container 107 is not permitted to be installed. Temporal restrictions may indicate one or more times of day, days of the week, seasons, event-based timeframes (e.g., during a sports game, during a rush hour commute, during a workday, etc.), etc. during which a given container 107 is permitted to be installed, instantiated, activated, etc. Additionally, or alternatively, temporal restrictions may indicate one or more times during which a given container 107 is not permitted to be installed, instantiated, activated, etc.

In this manner, returning to FIG. 1, orchestration platform 101 may maintain separate sets of parameters 109 for each container 107 out of a set of available containers 107. In some embodiments, container repository 103 may thus be considered a “library” or “pool” of available containers 107. As discussed above, some services may utilize multiple containers 107, as indicated by service information repository 105. For example, as shown, service information repository 105 may store information associating particular services with service attributes and/or containers that implement such services. As shown, for instance, a first service (represented as “Service 1”) may be associated with a first set of attributes (represented as “Attr 1”) and a first set of containers 107 (i.e., containers 107-1 and 107-3, in this example). A second service may be associated with a second set of attributes and a different second set of containers 107 (i.e., container 107-2, in this example). Other services, for which service information repository 105 stores information, may be associated with other attributes and/or sets of containers.

Service attributes may include, for example, tags, categories, labels, performance thresholds, QoS requirements, etc. associated with particular services. For example, an autonomous vehicle service may include attributes such as “latency-sensitive,” “autonomous vehicle,” “self-driving,” “automated factory robot,” “machine learning,” and/or other attributes. As another example, an AR service may include attributes such as “augmented reality,” “computer vision,” etc. In some embodiments, the association of service attributes to particular services may be specified manually by a network operator, application provider, administrator, etc. Additionally, or alternatively, the association of service attributes to particular services may be determined and/or refined via AI/ML techniques or other suitable techniques.

Container information for a given service may specify a particular set of containers 107 (e.g., one or more containers 107) that operate together to provide, implement, etc. the service. In some embodiments, containers 107 may be specified in a sequence or chain, or particular outputs of one container 107 may be specified as input to one or more other containers 107. For example, as noted above, an autonomous vehicle control service may be associated with one container 107 that handles real time processing such as image or video recognition, and another container 107 that handles non-real time processing such as AI/ML model generation or refinement. As another example, another autonomous vehicle control service may include a first container 107 that performs image or video recognition, and a second container 107 that receives or processes Light Detection and Ranging (“LIDAR”) information, and a third container 107 that generates a throttle and/or a braking control signal based on the output of the first and second containers 107.

In some embodiments, the containers 107 referenced in the information stored by service information repository 105 may refer to names, identifiers, etc. of containers 107 stored in container repository 103. Additionally, or alternatively, the containers 107 references in the information stored service information repository 105 may include tags, labels, criteria, types, and/or other attributes of containers 107. In this manner, static sets or chains of containers 107 may not necessarily need to be configured to provide a given service, in embodiments where attributes or parameters 109 of containers 107 may be identified based on service attributes (e.g., where attributes or parameters 109 of containers 107 match or otherwise correspond to attributes of a given service).

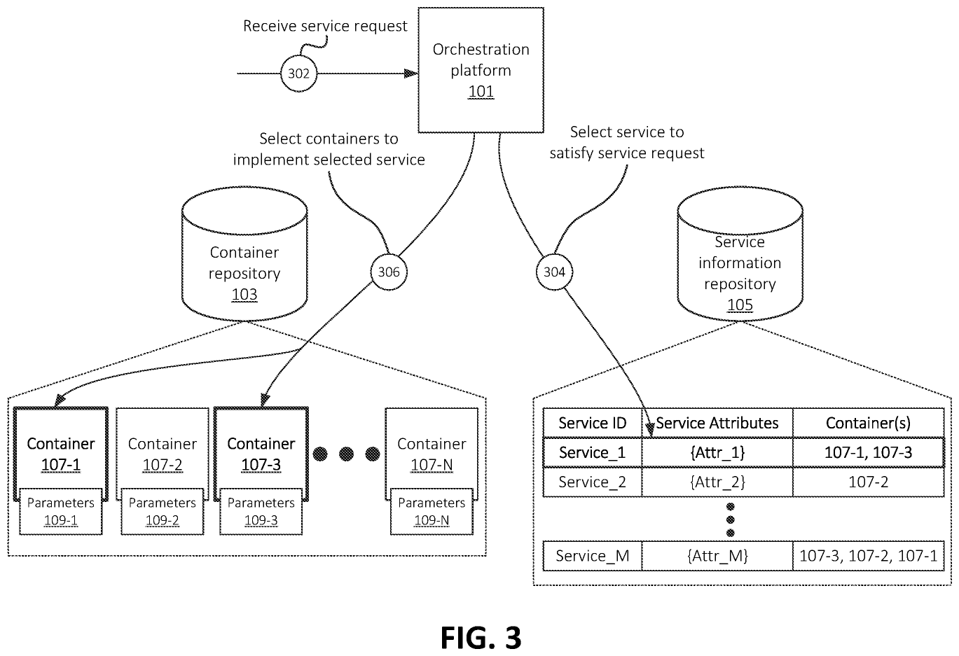

For example, as shown in FIG. 3, orchestration platform 101 may receive a service request, which may specify a particular service (e.g., by name or identifier), may include a natural language query, may include a set of keywords, and/or may otherwise include attributes or parameters of a requested service. Orchestration platform 101 may receive such a request via an application programming interface (“API”), a web portal, or some other suitable communication pathway. For example, the request may be made by a network operator, an administrator, and/or some other user. Additionally, or alternatively, the request may be received from another container 107, an application server, a UE, and/or some other device or system.

Based on receiving the request, orchestration platform 101 may select (at 304) a particular service to satisfy the service request. For example, orchestration platform 101 may identify information stored by service information repository 105 that matches a service identifier or name included in the service request, in situations where the service request specifies a particular service. Additionally, or alternatively, in situations where the service request includes a natural language query, a set of keywords or other attributes, orchestration platform 101 may identify a particular service for which the service attributes match the natural language query, the set of keywords, etc. specified in the service request. For example, orchestration platform 101 may utilize Natural Language Processing (“NLP”), AI/ML techniques, or other suitable techniques to identify classifications, intents, labels, scores, vectors, etc. based on the natural language query, the set of keywords, etc. specified in the service request. Orchestration platform 101 may utilize suitable search techniques, similarity scoring techniques, and/or other suitable techniques to select (at 304) a service with a set of attributes that are a “best match” or “best fit” for the natural language query, the set of keywords, etc. specified in the service request.

In this example, assume that orchestration platform 101 selected (at 304) Service_1 based on the service request. For example, the service request may have specifically identified Service_1, and/or may have included keywords or other parameters based on which orchestration platform 101 selected Service_1 by comparing the keywords or other parameters of the service request to service attributes of Service_1 and/or other services. Orchestration platform 101 may further select (at 306) a particular set of containers 107 (i.e., containers 107-1 and 107-3, in this example) to implement the selected service. For example, the information in service information repository 105 may specify that containers 107-1 and 107-3 are the specific containers 107 (e.g., out of the containers 107 stored in container repository 103) to implement the selected service. In some embodiments, as noted above, service information repository 105 may include conditions, parameters, etc. of containers 107 (e.g., container type, container performance thresholds, inputs and/or outputs, etc.) to implement the particular service. In such embodiments, orchestration platform 101 may compare attributes, parameters, etc. of containers 107 specified in service information repository 105 (e.g., as specified by information associated with the selected service) to parameters 109 of containers 107 included in container repository 103, in order to identify a set of containers 107 to implement the selected service.

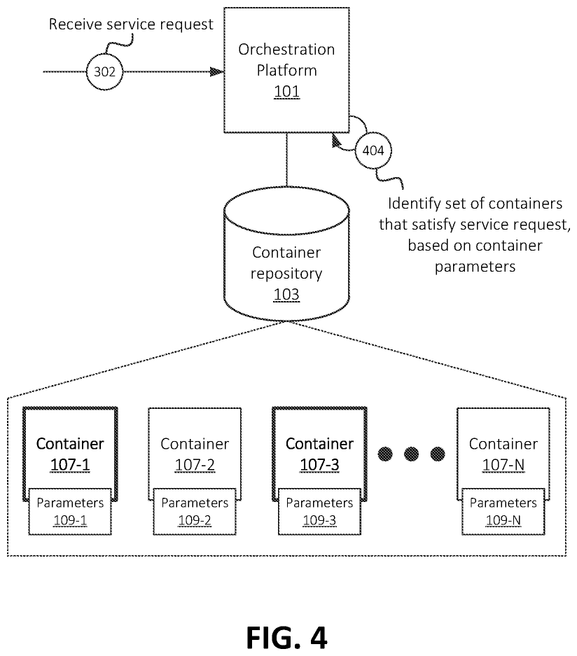

In some embodiments, as shown in FIG. 4, orchestration platform 101 may identify (at 404) a set of containers to implement a received (at 302) service request, without first selecting a service from service information repository 105. For example, orchestration platform 101 may identify keywords, attributes, etc. specified in the service request, and may identify a set of containers 107 to satisfy the request by comparing, matching, etc. parameters 109 of respective containers 107 to the keywords, attributes, etc. specified in the service request using NLP techniques, AI/ML, techniques, or other suitable techniques.

Once orchestration platform 101 has identified (e.g., at 306 and/or 404) the set of containers 107 to satisfy the service request (received at 302), orchestration platform 101 may identify particular nodes of a virtualized environment at which to install, instantiate, etc. the selected containers 107. Generally, orchestration platform 101 may select nodes based on parameters 109 of the selected containers 107 (e.g., to satisfy QoS requirements, satisfy container dependencies, etc.). Orchestration platform 101 may also select nodes based on attributes of the nodes themselves, such as locations of a network and/or attributes of hardware resources associated with the nodes, such that parameters 109 of the selected containers 107 are satisfied, met, accounted for, etc.

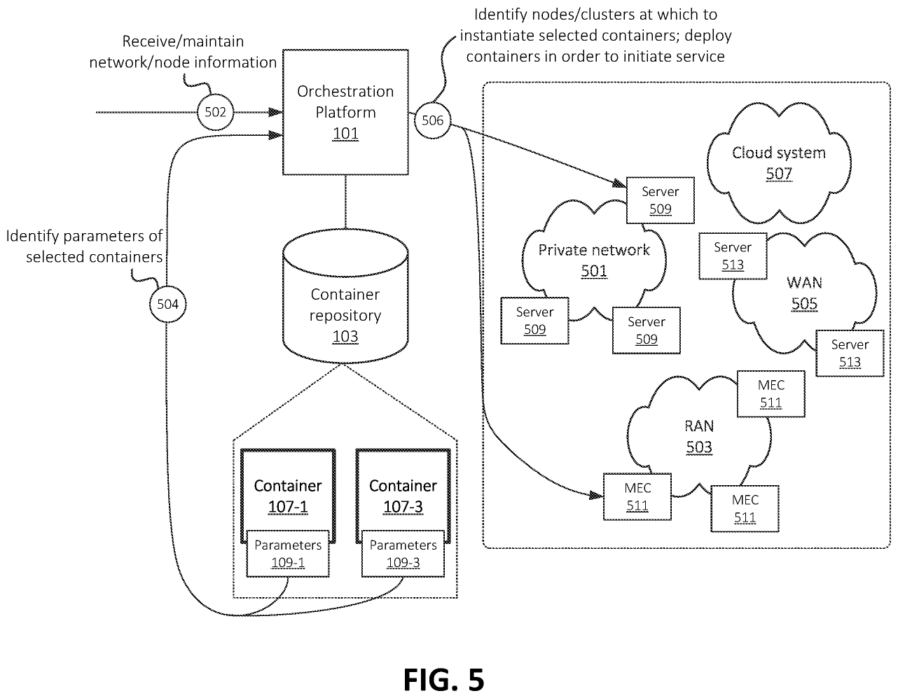

For example, as shown in FIG. 5, orchestration platform 101 may receive and/or maintain (at 502) information regarding nodes associated with one or more networks, and/or nodes associated with one or more clusters. For example, one cluster of nodes may correspond to a particular network and/or to some other group of nodes. In this example, the networks may include private network 501, RAN 503, and wide area network (“WAN”) 505. In this example, another set of nodes may be associated with cloud system 507.

In some embodiments, the nodes associated with each network or system (e.g., private network 501, RAN 503, WAN 505, cloud system 507, etc.) may be implemented by particular types of devices, collections of devices, virtual machines, and/or other types of hardware resources. As one example, private network 501 may include, may be communicatively coupled to, and/or may otherwise be associated with a set of servers 509. As another example, RAN 503 may include, may include, may be communicatively coupled to, and/or may otherwise be associated with a set of MECs 511. As another example, another set of servers 513 and/or other types of devices may be reachable via WAN 505. In some embodiments, cloud system 507 may include one or multiple nodes. For example, in some situations, cloud system 507 may be one logical node, with internal logic and/or routing to implement the logical node via different sets of hardware resources. While some examples of networks and/or devices that are associated with such networks are presented above, in practice, other types of networks and/or devices may be implemented via a virtualized environment.

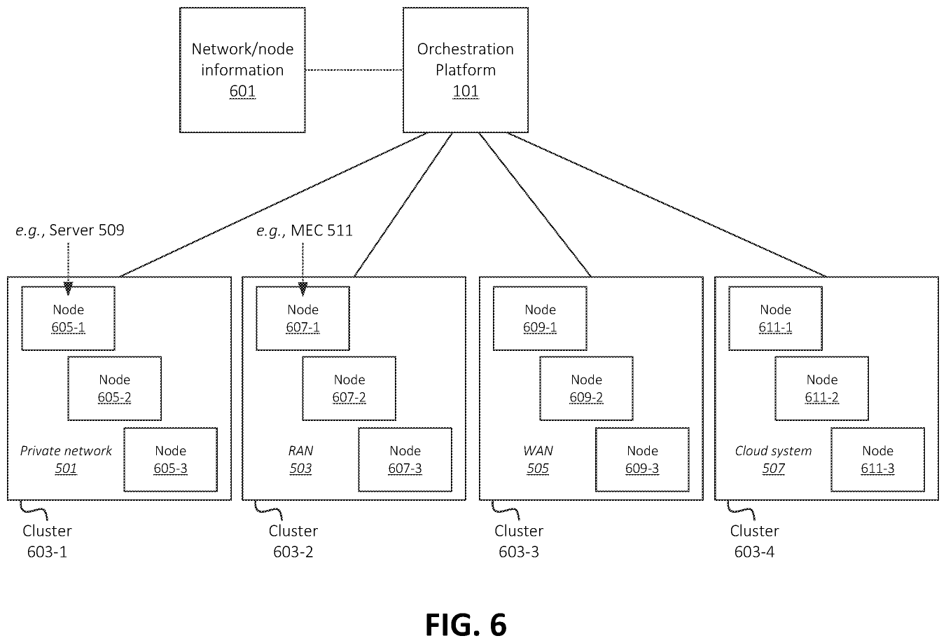

FIG. 6 illustrates another example representation of the networks and/or nodes shown in FIG. 5 (e.g., as represented by network/node information 601 which may be received or maintained (at 502) by orchestration platform 101). Network/node information 601 may include information regarding clusters, which may each include one or more nodes. In some embodiments, network/node information 601 may include configuration information, parameters, etc. associated with a containerization protocol, mechanism, API, etc., such as the open-source Kubernetes system. Orchestration platform 101 may be, may include, may be communicatively coupled to, and/or may otherwise be associated with the same containerization protocol, mechanism, API, etc. (e.g., the Kubernetes system or some other suitable system). Orchestration platform 101 may, for example, be capable of configuring nodes and/or clusters, such as adding or removing nodes to or from clusters, adding or removing containers 107 to or from nodes, configuring communication pathways between nodes and/or clusters, and/or other suitable operations.

As shown, for example, network/node information 601 may include information regarding a set of example clusters 603 (i.e., clusters 603-1 through 603-4, in this example). In some embodiments, each cluster 603 may be associated with a particular network or system, such as the networks or systems shown in FIG. 5. For example, cluster 603-1 may implement and/or otherwise represent private network 501, cluster 603-2 may implement and/or otherwise represent RAN 503, cluster 603-3 may implement and/or otherwise represent WAN 505, and cluster 603-4 may implement and/or otherwise represent cloud system 507. Each cluster may include one or more respective nodes, which may be implemented by respective sets of hardware resources, as noted above. For example, cluster 603-1 may include one or more nodes 605 (e.g., where each node 605 is implemented by or is otherwise associated with a particular server 509), cluster 603-2 may include one or more nodes 607 (e.g., where each node 607 is implemented by or is otherwise associated with a particular MEC 511), cluster 603-3 may include one or more nodes 609 (e.g., where each node 609 is implemented by or is otherwise associated with a particular server 513), and cluster 603-4 may include one or more nodes 611.

In some embodiments, nodes associated with particular clusters 613 may include nodes other than nodes on which particular containers 107 will be installed, such as nodes implementing network elements such as routers, firewalls, controllers, or other suitable network elements. These nodes may include configurable parameters such as QoS parameters, such that configuring these nodes may cause the network elements implemented by these nodes to route, forward, process, etc. particular traffic (e.g., traffic associated with one or more services) in accordance with suitable QoS parameters or other parameters. Further, while particular examples of types of hardware resources that may implement nodes are provided (e.g., servers 509, MECs 511, servers 513, etc.), in practice, other types of hardware resources may implement these nodes. Additionally, the same cluster 603 may include nodes that are implemented by diverse types of hardware resources (e.g., the same cluster 603 may include a set of nodes implemented by one or more MECs 511, and another set of nodes implemented by a set of servers, datacenters, etc.).

Network/node information 601 may also include attributes, characteristics, etc. associated with each cluster 603 and/or nodes associated with each respective cluster 603. For example, network/node information 601 may indicate a type, category, tags, etc. of a respective network, device, or system with which a given cluster 603 is associated. For example, network/node information 601 may indicate that cluster 603-1 is associated with a particular private network (e.g., may include an identifier of the particular private network), may indicate that cluster 603-2 is associated with a particular RAN, etc. As another example, network/node information 601 may include cluster dependency and/or routing information, such as information indicating a sequence in which traffic traverses respective networks or systems. For example, network/node information 601 may indicate that, in the uplink direction, traffic sent by a particular UE would be received by RAN 503 first (e.g., by one or more nodes 607 of cluster 603-2), then by private network 501 (e.g., by one or more nodes 605 of cluster 603-1), and then by either WAN 505 (e.g., by one or more nodes 609 of cluster 603-3) and/or by cloud system 507 (e.g., by one or more nodes 611 of cluster 603-4). In some embodiments, network/node information 601 may include location information associated with particular nodes and/or clusters, performance monitoring information regarding particular nodes and/or clusters (e.g., may receive or monitor performance, load, etc. of one or more networks over time), and/or other suitable information.

Returning to FIG. 5, orchestration platform 101 may identify parameters 109 of containers 107 that were selected (e.g., at 306 and/or 404) to implement a given service and/or to otherwise fulfill a service request. For example, orchestration platform 101 may identify QoS thresholds (e.g., latency thresholds, throughput thresholds, etc.), container dependence information, etc., and identify (at 506) particular nodes and/or clusters at which to instantiate, install, etc. the selected containers 107. For example, based on network/node information 601, orchestration platform 101 may identify particular clusters 603 at which the selected containers 107 should be instantiated, installed, etc. Orchestration platform 101 may, in some embodiments, identify clusters that correspond to the routing of traffic associated with the service to and/or from a particular UE (e.g., a UE receiving the service). For example, if the UE is connected to a particular RAN 503, orchestration platform 101 may select a corresponding cluster 603 associated with RAN 503. As another example, if a particular cluster 603 is associated with QoS parameters, performance metrics, etc. that satisfy QoS thresholds associated with a given container 107, orchestration platform 101 may select such cluster 603. As yet another example, if a particular cluster 603 is associated with a particular location (e.g., a location that is proximate to the location of a UE receiving the service, a location specified in parameters 109 of a given selected container 107, etc.), orchestration platform 101 may select such cluster 603. As another example, orchestration platform 101 may select one cluster 603 over another based on relative measures of load associated with different clusters 603 (e.g., may select a less-loaded cluster).

In some embodiments, orchestration platform 101 may select particular nodes within clusters based on similar factors, and/or may select nodes without first selecting clusters. For example, orchestration platform 101 may select particular nodes at which to instantiate selected containers 107 based on location, performance metrics, network load, and/or other parameters 109 associated with the selected containers 107. Orchestration platform 101 may accordingly instantiate (at 506) the selected containers 107 at the particular clusters 603 and/or nodes within such clusters 603.

In some embodiments, as part of deploying the service, orchestration platform 101 may further configure other nodes of one or more other clusters (e.g., in addition to instantiating selected containers 107). For example, in some embodiments, one or more nodes of one or more clusters may implement Virtualized Network Function (“VNFs”), routers, firewalls, etc. As part of identifying (at 506) nodes and/or clusters via which the service will be provided, orchestration platform 101 may further identify nodes and/or clusters associated with network elements that carry, process, route, forward, etc. traffic associated with the service, and may configure such nodes and/or clusters based on parameters 109 associated with the service. For example, orchestration platform 101 may configure a particular node of RAN 503, which implements a base station, a Distributed Unit (“DU”), and/or some other element of RAN 503, based on QoS parameters associated with a particular service. As another example, orchestration platform 101 may configure a particular node of private network 501 (e.g., which implements a firewall, a routing element, etc.) based on QoS parameters associated with the particular service. In this manner, the service may be provided in accordance with QoS parameters (e.g., latency, throughput, etc.) that provide at least a threshold measure of performance, user experience, etc.

Although examples described above were provided in the context of a single service being deployed (e.g., containers 107 associated with the service being identified and instantiated at respective nodes associated with one or more networks, as well as additional configuration parameters being provided to the network in order to deliver at least a threshold measure of performance), similar operations may be performed in order to deploy multiple services to the same or different nodes and/or clusters. In some embodiments, each service may be associated with a particular namespace, domain, etc. As such, each container 107 of a particular service may be able to communicate with each other in order to provide the service, but may be unable to communicate with containers 107 of other services (e.g., associated with other namespaces, domains, etc.). In this manner, security of each service may be preserved. In some embodiments, different services may have interfaces, APIs, “hooks,” etc., via which a particular service may communicate with another service. In this manner, multiple services may communicate with each other in order to provide a coordinated set of services.

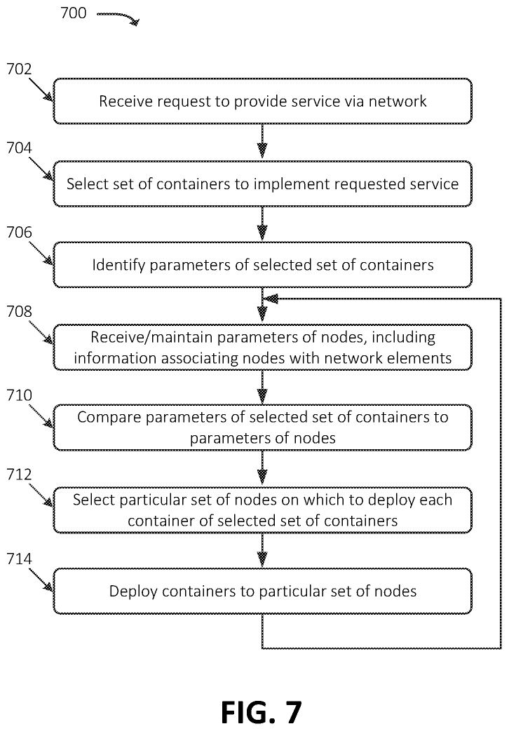

FIG. 7 illustrates an example process 700 for deploying a set of containers 107 to a set of nodes in order to automatically implement a requested service. In some embodiments, some or all of process 700 may be performed by orchestration platform 101. In some embodiments, one or more other devices may perform some or all of process 700 in concert with, and/or in lieu of, orchestration platform 101.

As shown, process 700 may include receiving (at 702) a request to provide a service via a network. For example, as discussed above, the request may include a name or identifier of a particular service, an identifier of a set of containers, a natural language query, a set of keywords, and/or other suitable information. The request may be received from an administrator, operator, or other user. Additionally, or alternatively, in some embodiments, the request may be received via an API (e.g., from some other device or system).

Process 700 may further include selecting (at 704) a set of containers to implement the requested service. For example, as discussed above, orchestration platform 101 may identify parameters 109 of respective containers 107 (e.g., from a library, pool, etc. of candidate containers 107, such a container repository 103) that match the request and/or that would otherwise satisfy the request. For example, in situations where the request specifies a particular service, orchestration platform 101 may identify respective containers 107 that are associated with the service (e.g., as discussed above with respect to service information repository 105). In some embodiments, orchestration platform 101 may perform NLP techniques or other suitable techniques to identify an intent or other parameters of the service request (e.g., in situations where the service request includes natural language, keywords, etc.), and may identify a particular service based on the determined intent. Orchestration platform 101 may accordingly select the set of containers 107 associated with the identified service, as the set of containers 107 to satisfy the service request. Additionally, or alternatively, orchestration platform 101 may select the set of containers 107 in some other manner, such as by comparing parameters 109 of containers 107 to the intent, keywords, etc. included in or otherwise associated with the service request.

Process 700 may additionally include identifying (at 706) parameters of the selected set of containers. For example, as discussed above, orchestration platform 101 may identify parameters 109 of containers 107 that were selected (at 704) to satisfy the service request. For example, as discussed above, orchestration platform 101 may identify QoS requirements, hardware requirements, container dependencies, etc. associated with some or all of the containers 107 of the selected set of containers 107.

Process 700 may also include receiving and/or maintaining (at 708) parameters of nodes of a virtualized environment. The parameters may, as discussed above, include information associating particular nodes with particular network elements, particular networks, or other devices or systems. For example, as discussed above, the parameters may indicate that some nodes are associated with a first network or system (e.g., private network 501), that other nodes are associated with a second network or system (e.g., RAN 503), that other nodes are associated with a third network or system (e.g., cloud system 507), etc. The parameters may include or be based on network topology or routing information, such as information specifying that traffic associated with the requested service (e.g., between a UE receiving the service and one or more nodes providing the service) will traverse, will be routed by, will be processed by, etc. particular networks or network elements (e.g., routers, firewalls, etc.). In some embodiments, orchestration platform 101 may also receive performance or load information associated with one or more networks or network elements, such as used or available throughput, latency metrics, etc. In some embodiments, orchestration platform 101 may receive such performance or load information on an ongoing basis (e.g., periodically, intermittently, etc.), such that orchestration platform 101 may maintain up-to-date, or relatively up-to-date, performance and/or load monitoring information associated with the networks or network elements.

Process 700 may further include comparing (at 710) parameters of the selected set of containers to the parameters of the nodes, and selecting (at 712) a particular set of nodes on which to deploy each container of the selected set of containers. For example, orchestration platform 101 may identify particular nodes, or sets of nodes, that satisfy QoS requirements, hardware requirements, and/or other parameters 109 of containers 107. The selected set of containers may also be selected with respect to network topology information, based on which orchestration platform 101 may determine inter-node communication latency metrics or other suitable metrics. For example, if two nodes are each associated with relatively fast processing times but have relatively high latency for traffic between the two nodes, an overall performance metric associated with the two nodes may be relatively low due to the high latency, despite the fast processing times associated with the two nodes. Orchestration platform 101 may also select nodes based on load metrics associated with particular network elements that implement nodes, and/or based on load metrics associated with network elements that route, forward, etc. traffic between nodes. For example, orchestration platform 101 may avoid selecting a node, that is relatively overloaded, to implement a selected container 107. As another example, orchestration platform 101 may avoid selecting a node for which latency of traffic to and/or from the node is relatively high.

Process 700 may also include deploying (at 714) the selected set of containers 107 to the particular set of nodes. For example, orchestration platform 101 may install, instantiate, etc. the selected containers 107 to the selected set of nodes. Orchestration platform 101 may also configure one or more other network elements or nodes in addition to the nodes on which the set of containers 107 are deployed. For example, orchestration platform 101 may configure RAN 503, to which a UE receiving the service is connected, to treat traffic associated with the service with a particular set of QoS parameters, priority levels, network slice, subnet, etc. For example, orchestration platform 101 may provide a name or other identifier of the service, endpoint identifiers associated with the service (e.g., an Internet Protocol (“IP”) address, port number, etc. of one or more nodes that implement the service), or other identifiable traffic attributes or descriptors to a controller, interface, etc. associated with RAN 503. Based on such information, RAN 503 may provide the requested QoS parameters to traffic associated with the service. Similarly, orchestration platform 101 may configure other types of networks to handle service traffic according to such QoS parameters, such as firewalls, routers, etc. of one or more suitable types of networks (e.g., private network 501, WAN 505, cloud system 507, etc.).

In some embodiments, some or all of process 700 may be repeated iteratively and/or on an ongoing basis, in order to account for changing network conditions and in order to maintain QoS parameters or other service parameters. For example, orchestration platform 101 may continue to monitor, receive, etc. (at 708) performance information, load information, etc. associated with the nodes and/or other network elements, and may adjust the deployment of containers 107 accordingly. For example, if a given node becomes overloaded, or communications between respective nodes exceed a threshold latency, orchestration platform 101 may redeploy containers 107 deployed to such nodes in order to restore the QoS metrics associated with the service.

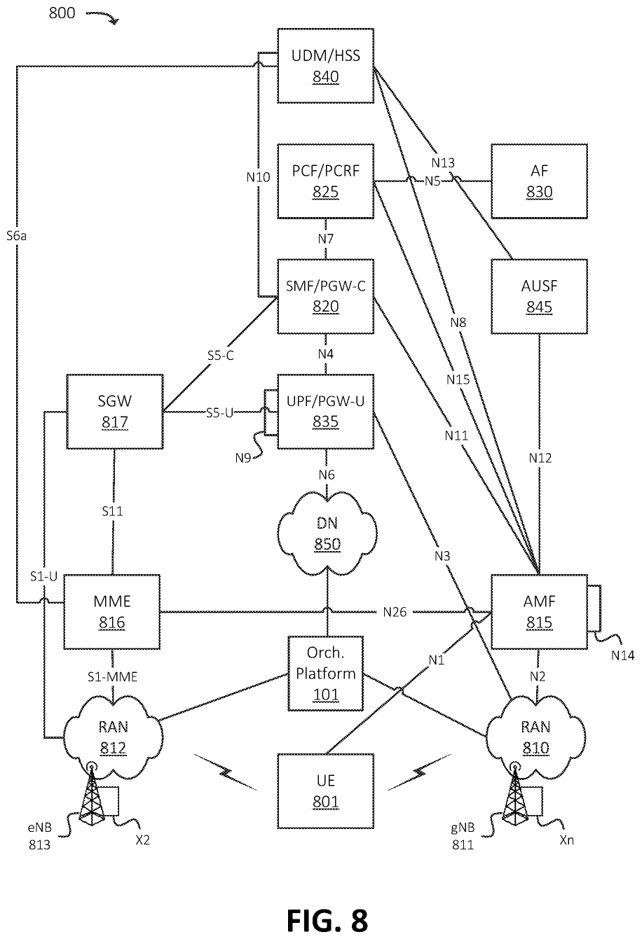

FIG. 8 illustrates an example environment 800, in which one or more embodiments may be implemented. In some embodiments, environment 800 may correspond to a Fifth Generation (“5G”) network, and/or may include elements of a 5G network. In some embodiments, environment 800 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 800 may represent or may include a 5G core (“5GC”). As shown, environment 800 may include UE 801, RAN 810 (which may include one or more Next Generation Node Bs (“gNBs”) 811), RAN 812 (which may include one or more evolved Node Bs (“eNBs”) 813), and various network functions such as Access and Mobility Management Function (“AMF”) 815, Mobility Management Entity (“MME”) 816, Serving Gateway (“SGW”) 817, Session Management Function (“SMF”)/Packet Data Network (“PDN”) Gateway (“PGW”)-Control plane function (“PGW-C”) 820, Policy Control Function (“PCF”)/Policy Charging and Rules Function (“PCRF”) 825, Application Function (“AF”) 830, User Plane Function (“UPF”)/PGW-User plane function (“PGW-U”) 835, Unified Data Management (“UDM”)/Home Subscriber Server (“HSS”) 840, and Authentication Server Function (“AUSF”) 845. Environment 800 may also include one or more networks, such as Data Network (“DN”) 850. Environment 800 may include one or more additional devices or systems communicatively coupled to one or more networks (e.g., DN 850), such as orchestration platform 101.

As noted above, some or all of environment 800 may be implemented as a virtualized environment, in which one or more elements of environment 800 (e.g., AMF 815, UPF/PGW-U 835, SMF/PGW-C 820, etc.) may be implemented by one or more nodes of a virtualized environment. In some embodiments, routing elements and/or other network elements not specifically shown in FIG. 8 may be implemented by one or more nodes of the virtualized environment. In some embodiments, as discussed above, orchestration platform 101 may configure, provision, install, remove, etc. particular nodes from hardware resources that implement the nodes, and/or may install containers (e.g., which include functionality of one or more VNFs, Cloud-native Network Functions (“CNFs”), etc.) on such nodes.

The example shown in FIG. 8 illustrates one instance of each network component or function (e.g., one instance of SMF/PGW-C 820, PCF/PCRF 825, UPF/PGW-U 835, UDM/HSS 840, and/or AUSF 845). In practice, environment 800 may include multiple instances of such components or functions. For example, in some embodiments, environment 800 may include multiple “slices” of a core network, where each slice includes a discrete and/or logical set of network functions (e.g., one slice may include a first instance of SMF/PGW-C 820, PCF/PCRF 825, UPF/PGW-U 835, UDM/HSS 840, and/or AUSF 845, while another slice may include a second instance of SMF/PGW-C 820, PCF/PCRF 825, UPF/PGW-U 835, UDM/HSS 840, and/or AUSF 845). The different slices may provide differentiated levels of service, such as service in accordance with different Quality of Service (“QoS”) parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. Alternatively, or additionally, one or more of the devices of environment 800 may perform one or more network functions described as being performed by another one or more of the devices of environment 800. Devices of environment 800 may interconnect with each other and/or other devices via wired connections, wireless connections, or a combination of wired and wireless connections. In some implementations, one or more devices of environment 800 may be physically integrated in, and/or may be physically attached to, one or more other devices of environment 800.

UE 801 may include a computation and communication device, such as a wireless mobile communication device that is capable of communicating with RAN 810, RAN 812, and/or DN 850. UE 801 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), or another type of mobile computation and communication device. UE 801 may send traffic to and/or receive traffic (e.g., user plane traffic) from DN 850 via RAN 810, RAN 812, and/or UPF/PGW-U 835.

RAN 810 may be, or may include, a 5G RAN that includes one or more base stations (e.g., one or more gNBs 811), via which UE 801 may communicate with one or more other elements of environment 800. UE 801 may communicate with RAN 810 via an air interface (e.g., as provided by gNB 811). For instance, RAN 810 may receive traffic (e.g., voice call traffic, data traffic, messaging traffic, signaling traffic, etc.) from UE 801 via the air interface, and may communicate the traffic to UPF/PGW-U 835, and/or one or more other devices or networks. Similarly, RAN 810 may receive traffic intended for UE 801 (e.g., from UPF/PGW-U 835, AMF 815, and/or one or more other devices or networks) and may communicate the traffic to UE 801 via the air interface.

RAN 812 may be, or may include, a LTE RAN that includes one or more base stations (e.g., one or more eNBs 813), via which UE 801 may communicate with one or more other elements of environment 800. UE 801 may communicate with RAN 812 via an air interface (e.g., as provided by eNB 813). For instance, RAN 812 may receive traffic (e.g., voice call traffic, data traffic, messaging traffic, signaling traffic, etc.) from UE 801 via the air interface, and may communicate the traffic to UPF/PGW-U 835, and/or one or more other devices or networks. Similarly, RAN 812 may receive traffic intended for UE 801 (e.g., from UPF/PGW-U 835, SGW 817, and/or one or more other devices or networks) and may communicate the traffic to UE 801 via the air interface.

AMF 815 may include one or more devices, systems, VNFs, CNFs, etc., that perform operations to register UE 801 with the 5G network, to establish bearer channels associated with a session with UE 801, to hand off UE 801 from the 5G network to another network, to hand off UE 801 from the other network to the 5G network, manage mobility of UE 801 between RANs 810 and/or gNBs 811, and/or to perform other operations. In some embodiments, the 5G network may include multiple AMFs 815, which communicate with each other via the N14 interface (denoted in FIG. 8 by the line marked “N14” originating and terminating at AMF 815).

MME 816 may include one or more devices, systems, VNFs, CNFs, etc., that perform operations to register UE 801 with the EPC, to establish bearer channels associated with a session with UE 801, to hand off UE 801 from the EPC to another network, to hand off UE 801 from another network to the EPC, manage mobility of UE 801 between RANs 812 and/or eNBs 813, and/or to perform other operations.

SGW 817 may include one or more devices, systems, VNFs, CNFs, etc., that aggregate traffic received from one or more eNBs 813 and send the aggregated traffic to an external network or device via UPF/PGW-U 835. Additionally, SGW 817 may aggregate traffic received from one or more UPF/PGW-Us 835 and may send the aggregated traffic to one or more eNBs 813. SGW 817 may operate as an anchor for the user plane during inter-eNB handovers and as an anchor for mobility between different telecommunication networks or RANs (e.g., RANs 810 and 812).

SMF/PGW-C 820 may include one or more devices, systems, VNFs, CNFs, etc., that gather, process, store, and/or provide information in a manner described herein. SMF/PGW-C 820 may, for example, facilitate the establishment of communication sessions on behalf of UE 801. In some embodiments, the establishment of communications sessions may be performed in accordance with one or more policies provided by PCF/PCRF 825.

PCF/PCRF 825 may include one or more devices, systems, VNFs, CNFs, etc., that aggregate information to and from the 5G network and/or other sources. PCF/PCRF 825 may receive information regarding policies and/or subscriptions from one or more sources, such as subscriber databases and/or from one or more users (such as, for example, an administrator associated with PCF/PCRF 825).

AF 830 may include one or more devices, systems, VNFs, CNFs, etc., that receive, store, and/or provide information that may be used in determining parameters (e.g., quality of service parameters, charging parameters, or the like) for certain applications.

UPF/PGW-U 835 may include one or more devices, systems, VNFs, CNFs, etc., that receive, store, and/or provide data (e.g., user plane data). For example, UPF/PGW-U 835 may receive user plane data (e.g., voice call traffic, data traffic, etc.), destined for UE 801, from DN 850, and may forward the user plane data toward UE 801 (e.g., via RAN 810, SMF/PGW-C 820, and/or one or more other devices). In some embodiments, multiple UPFs 835 may be deployed (e.g., in different geographical locations), and the delivery of content to UE 801 may be coordinated via the N9 interface (e.g., as denoted in FIG. 8 by the line marked “N9” originating and terminating at UPF/PGW-U 835). Similarly, UPF/PGW-U 835 may receive traffic from UE 801 (e.g., via RAN 810, SMF/PGW-C 820, and/or one or more other devices), and may forward the traffic toward DN 850. In some embodiments, UPF/PGW-U 835 may communicate (e.g., via the N4 interface) with SMF/PGW-C 820, regarding user plane data processed by UPF/PGW-U 835.

UDM/HSS 840 and AUSF 845 may include one or more devices, systems, VNFs, CNFs, etc., that manage, update, and/or store, in one or more memory devices associated with AUSF 845 and/or UDM/HSS 840, profile information associated with a subscriber. AUSF 845 and/or UDM/HSS 840 may perform authentication, authorization, and/or accounting operations associated with the subscriber and/or a communication session with UE 801.

DN 850 may include one or more wired and/or wireless networks. For example, DN 850 may include an IP-based PDN, a WAN such as the Internet, a private enterprise network, and/or one or more other networks. UE 801 may communicate, through DN 850, with data servers, other UEs 801, and/or to other servers or applications that are coupled to DN 850. DN 850 may be connected to one or more other networks, such as a public switched telephone network (“PSTN”), a public land mobile network (“PLMN”), and/or another network. DN 850 may be connected to one or more devices, such as content providers, applications, web servers, and/or other devices, with which UE 801 may communicate.

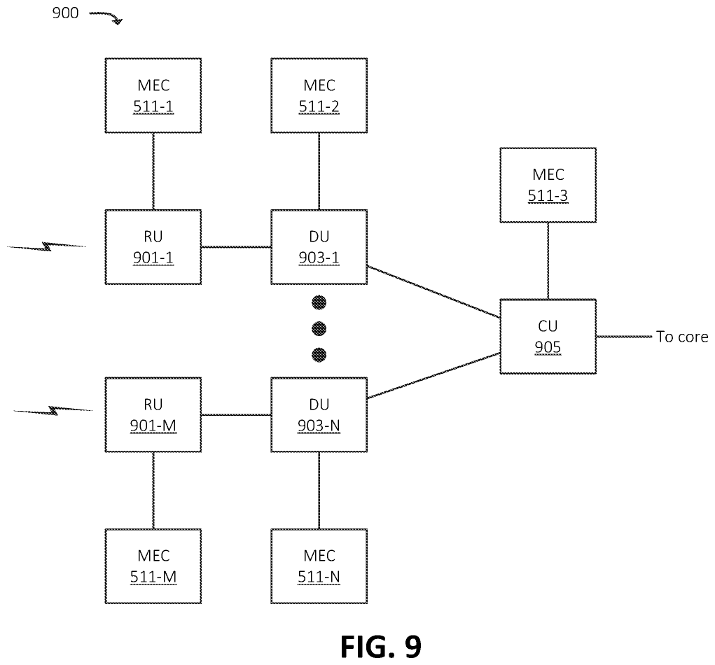

FIG. 9 illustrates an example RAN environment 900, which may be included in and/or implemented by one or more RANs (e.g., RAN 810, RAN 812, or some other RAN). In some embodiments, a particular RAN may include one RAN environment 900. In some embodiments, a particular RAN may include multiple RAN environments 900. In some embodiments, RAN environment 900 may correspond to a particular gNB 811 of a 5G RAN (e.g., RAN 810). In some embodiments, RAN environment 900 may correspond to multiple gNBs 811. In some embodiments, RAN environment 900 may correspond to one or more other types of base stations of one or more other types of RANs. As shown, RAN environment 900 may include Central Unit (“CU”) 905, one or more Distributed Units (“DUs”) 903-1 through 903-N (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 815 and/or UPF/PGW-U 835). In the uplink direction (e.g., for traffic from UEs 801 to a core network), CU 905 may aggregate traffic from DUs 903, and forward the aggregated traffic to the core network. In some embodiments, CU 905 may receive traffic according to a given protocol (e.g., Radio Link Control (“RLC”)) from DUs 903, and may perform higher-layer processing (e.g., may aggregate/process RLC packets and generate Packet Data Convergence Protocol (“PDCP”) packets based on the RLC packets) on the traffic received from DUs 903.

In accordance with some embodiments, CU 905 may receive downlink traffic (e.g., traffic from the core network) for a particular UE 801, and may determine which DU(s) 903 should receive the downlink traffic. DU 903 may include one or more devices that transmit traffic between a core network (e.g., via CU 905) and UE 801 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 801.

RU 901 may include hardware circuitry (e.g., one or more RF transceivers, antennas, radios, and/or other suitable hardware) to communicate wirelessly (e.g., via an RF interface) with one or more UEs 801, one or more other DUs 903 (e.g., via RUs 901 associated with DUs 903), and/or any other suitable type of device. In the uplink direction, RU 901 may receive traffic from UE 801 and/or another DU 903 via the RF interface and may provide the traffic to DU 903. In the downlink direction, RU 901 may receive traffic from DU 903, and may provide the traffic to UE 801 and/or another DU 903.

RUs 901 may, in some embodiments, be communicatively coupled to one or more Multi-Access/Mobile Edge Computing (“MEC”) devices, referred to sometimes herein simply as “MECs” 511. For example, RU 901-1 may be communicatively coupled to MEC 511-1, RU 901-M may be communicatively coupled to MEC 511-M, DU 903-1 may be communicatively coupled to MEC 511-2, DU 903-N may be communicatively coupled to MEC 511-N, CU 905 may be communicatively coupled to MEC 511-3, and so on. MECs 511 may include hardware resources (e.g., configurable or provisionable hardware resources) that may be configured to provide services and/or otherwise process traffic to and/or from UE 801, via a respective RU 901.

For example, RU 901-1 may route some traffic, from UE 801, to MEC 511-1 instead of to a core network via DU 903 and CU 905. MEC 511-1 may process the traffic, perform one or more computations based on the received traffic, and may provide traffic to UE 801 via RU 901-1. In some embodiments, MEC 511 may include, and/or may implement, some or all of the functionality described above with respect to orchestration platform 101, AF 830, UPF 835, and/or one or more other devices, systems, VNFs, CNFs, etc. In this manner, ultra-low latency services may be provided to UE 801, as traffic does not need to traverse DU 903, CU 905, and an intervening backhaul network between RAN environment 900 and the core network.

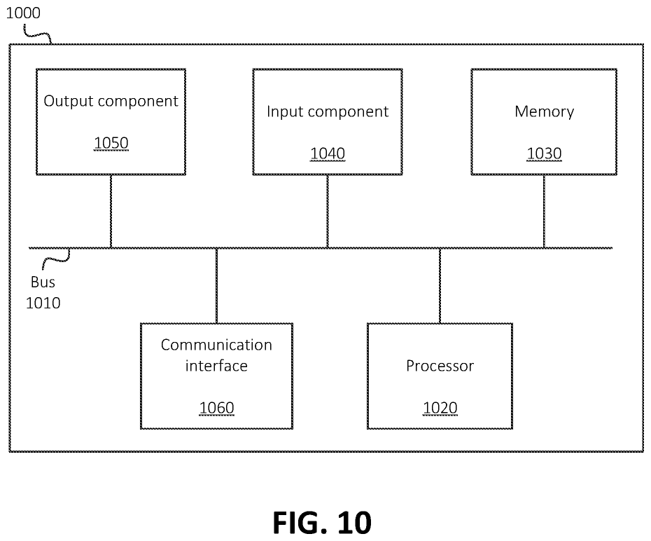

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-7), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive a request to provide a service via a network;
select a set of containers, from a plurality of candidate containers of a virtualized environment, to implement the requested service;
identify one or more parameters of one or more containers of the set of containers;
maintain information including parameters associated with a plurality of nodes of the virtualized environment, wherein the parameters for one or more of the plurality of nodes includes information associating the one or more nodes with respective elements of the network;
compare the parameters of the one or more containers to the parameters of the one or more nodes;
select, based on the comparing, a particular set of nodes of the plurality of nodes on which to deploy the selected set of containers,
wherein the selecting includes selecting, for each container of the set of containers, a respective node of the particular set of nodes on which to deploy the each container; and
deploy, to the particular set of nodes, the selected set of containers, wherein the deployed containers implement the requested service.

2. The device of claim 1, wherein the one or more processors are further configured to:
use Natural Language Processing (“NLP”) to identify one or more intents associated with a natural language query associated with the request,
wherein selecting the set of containers to implement the service includes selecting the set of containers based on the one or more intents.

3. The device of claim 2, wherein the one or more processors are further configured to:
identify information associating a plurality of services with a plurality of respective sets of containers; and
identify, based on the one or more intents, a particular service of the plurality of services,
wherein selecting the set of containers further includes selecting the respective set of containers that is associated with the particular service, wherein the particular service is the requested service.

4. The device of claim 1, wherein the one or more processors are further configured to:
configure one or more network elements based on the selected set of containers, in addition to deploying the selected set of containers to the particular set of nodes, in order to provide the service via the network.

5. The device of claim 4, wherein configuring the one or more network elements includes configuring one or more routing elements that route traffic between two or more of the nodes of the particular set of nodes.

6. The device of claim 1, wherein the service is a first service, wherein the selected set of containers is a first set of containers, wherein the particular set of nodes is a first set of nodes, wherein deploying the first set of containers to the first set of nodes includes associating the first set of containers with a first namespace, wherein the one or more processors are further configured to:
deploy a second set of containers to a second set of nodes to implement a second service, wherein deploying the second set of containers includes associating the second set of containers with a second namespace that is different from the first namespace.

7. The device of claim 1, wherein the information associating the one or more nodes with respective elements of the network includes information associating the nodes with respective hardware resources of the network.

8. A non-transitory computer-readable medium, storing a plurality of processor-executable instructions to:
receive a request to provide a service via a network;
select a set of containers, from a plurality of candidate containers of a virtualized environment, to implement the requested service;
identify one or more parameters of one or more containers of the set of containers;
maintain information including parameters associated with a plurality of nodes of the virtualized environment, wherein the parameters for one or more of the plurality of nodes includes information associating the one or more nodes with respective elements of the network;
compare the parameters of the one or more containers to the parameters of the one or more nodes;
select, based on the comparing, a particular set of nodes of the plurality of nodes on which to deploy the selected set of containers,
wherein the selecting includes selecting, for each container of the set of containers, a respective node of the particular set of nodes on which to deploy the each container; and
deploy, to the particular set of nodes, the selected set of containers, wherein the deployed containers implement the requested service.

9. The non-transitory computer-readable medium of claim 8, wherein the plurality of processor-executable instructions further include processor-executable instructions to:
use Natural Language Processing (“NLP”) to identify one or more intents associated with a natural language query associated with the request,
wherein selecting the set of containers to implement the service includes selecting the set of containers based on the one or more intents.

10. The non-transitory computer-readable medium of claim 9, wherein the plurality of processor-executable instructions further include processor-executable instructions to:
identify information associating a plurality of services with a plurality of respective sets of containers; and
identify, based on the one or more intents, a particular service of the plurality of services,
wherein selecting the set of containers further includes selecting the respective set of containers that is associated with the particular service, wherein the particular service is the requested service.

11. The non-transitory computer-readable medium of claim 8, wherein the plurality of processor-executable instructions further include processor-executable instructions to:
configure one or more network elements based on the selected set of containers, in addition to deploying the selected set of containers to the particular set of nodes, in order to provide the service via the network.

12. The non-transitory computer-readable medium of claim 11, wherein configuring the one or more network elements includes configuring one or more routing elements that route traffic between two or more of the nodes of the particular set of nodes.

13. The non-transitory computer-readable medium of claim 8, wherein the service is a first service, wherein the selected set of containers is a first set of containers, wherein the particular set of nodes is a first set of nodes, wherein deploying the first set of containers to the first set of nodes includes associating the first set of containers with a first namespace, wherein the plurality of processor-executable instructions further include processor-executable instructions to:
deploy a second set of containers to a second set of nodes to implement a second service, wherein deploying the second set of containers includes associating the second set of containers with a second namespace that is different from the first namespace.

14. The non-transitory computer-readable medium of claim 8, wherein the information associating the one or more nodes with respective elements of the network includes information associating the nodes with respective hardware resources of the network.

15. A method, comprising:
receiving a request to provide a service via a network;
selecting a set of containers, from a plurality of candidate containers of a virtualized environment, to implement the requested service;
identifying one or more parameters of one or more containers of the set of containers;
maintaining information including parameters associated with a plurality of nodes of the virtualized environment, wherein the parameters for one or more of the plurality of nodes includes information associating the one or more nodes with respective elements of the network;
comparing the parameters of the one or more containers to the parameters of the one or more nodes;
selecting, based on the comparing, a particular set of nodes of the plurality of nodes on which to deploy the selected set of containers,
wherein the selecting includes selecting, for each container of the set of containers, a respective node of the particular set of nodes on which to deploy the each container; and
deploying, to the particular set of nodes, the selected set of containers, wherein the deployed containers implement the requested service.

16. The method of claim 15, further comprising:
using Natural Language Processing (“NLP”) to identify one or more intents associated with a natural language query associated with the request;
identifying information associating a plurality of services with a plurality of respective sets of containers; and
identifying, based on the one or more intents, a particular service of the plurality of services,
wherein selecting the set of containers includes selecting the respective set of containers that is associated with the particular service, wherein the particular service is the requested service.

17. The method of claim 15, further comprising:
configuring one or more network elements based on the selected set of containers, in addition to deploying the selected set of containers to the particular set of nodes, in order to provide the service via the network.

18. The method of claim 17, wherein configuring the one or more network elements includes configuring one or more routing elements that route traffic between two or more of the nodes of the particular set of nodes.

19. The method of claim 15, wherein the service is a first service, wherein the selected set of containers is a first set of containers, wherein the particular set of nodes is a first set of nodes, wherein deploying the first set of containers to the first set of nodes includes associating the first set of containers with a first namespace, the method further comprising:
deploying a second set of containers to a second set of nodes to implement a second service, wherein deploying the second set of containers includes associating the second set of containers with a second namespace that is different from the first namespace.

20. The method of claim 15, wherein the information associating the one or more nodes with respective elements of the network includes information associating the nodes with respective hardware resources of the network.
